(19) United States
(12) Patent Application Publication
(10) Pub. No.: US 2026/0369456 A1
(43) Pub. Date: Nov. 19, 2026

(54) SOFT MAGNETIC METAL MAGNETIC POWDER, INDUCTOR, AND METHOD OF PRODUCING SOFT MAGNETIC METAL MAGNETIC POWDER

(71) Applicant: Murata Manufacturing Co., Ltd., Kyoto-fu (JP)

(72) Inventors: Takamitsu DEMURA, Nagaokakyo-shi, Kyoto (JP); Kazuhiro HENMI, Nagaokakyo-shi, Kyoto (JP)

(73) Assignee: Murata Manufacturing Co., Ltd., Kyoto-fu (JP)

(21) Appl. No.: 19/730,342

(22) Filed: Jul. 2, 2026

Related U.S. Application Data
(63) Continuation of application No. PCT/JP2024/044984, filed on Dec. 19, 2024.

(30) Foreign Application Priority Data
Mar. 19, 2024 (JP) 2024-044006

(51) Int. Cl. H01F 27/28; H01F 1/20; H01F 27/255

(52) U.S. Cl. CPC H01F 27/28; H01F 1/20; H01F 27/255

(57) ABSTRACT

A soft magnetic metal magnetic powder including soft magnetic metal particles coated with an insulating coating that has improved volume resistivity and slipperiness, an inductor, and a method of producing the soft magnetic metal magnetic powder. A soft magnetic metal powder has a soft magnetic metal particle and an insulating coating with which the soft magnetic metal particle is coated. The insulating coating contains sulfur in an amount of 350 ppm or more and 1390 ppm or less (i.e., from 350 ppm to 1390 ppm) based on the total amount of the insulating coating.

### CROSS-REFERENCE TO RELATED APPLICATIONS

This application claims benefit of priority to International Patent Application No. PCT/JP2024/044984, filed Dec. 19, 2024, and to Japanese Patent Application No. 2024-044006, filed Mar. 19, 2024, the entire contents of each are incorporated herein by reference.

### BACKGROUND

### Technical Field

The present disclosure relates to a soft magnetic metal magnetic powder, an inductor, and a method of producing the soft magnetic metal magnetic powder.

### Background Art

Electronic components such as inductors are widely used in power supply circuits of various electronic devices. Such an electronic component includes a coil and a magnetic core disposed inside the coil. In recent years, soft magnetic metal powders are widely used as a material for the magnetic core instead of ferrite, which has been traditionally used. Compared with ferrite, soft magnetic metal powders exhibit high saturation magnetization (saturation magnetic flux density) and excellent DC bias characteristics (a large allowable DC bias current), and are therefore suitable for miniaturization of electronic components (magnetic cores).

In the case where the soft magnetic metal powder is used for a magnetic core, an eddy current is likely to be generated in the magnetic core due to conduction between a plurality of soft magnetic metal particles contained in the soft magnetic metal powder. Specifically, in the case where the soft magnetic metal powder is used for a magnetic core, an eddy-current loss tends to occur. The eddy-current loss may lead to a decrease in efficiency of the power supply circuit, resulting in an increase in power consumption of the electronic device. Therefore, the eddy-current loss needs to be reduced, and for reducing the eddy-current loss, an insulating coating of the soft magnetic metal particles is required to have high volume resistivity.

In addition, for achieving a high withstand voltage, the soft magnetic metal particles need to be packed at high density with small gaps therebetween. This allows a larger amount of soft magnetic metal powder to contribute to withstanding high voltage. For the high packing density, the insulating coating with which the soft magnetic metal particles are coated is required to have high slipperiness.

As described above, the insulating coating with which the soft magnetic metal particles are coated has been required to have high volume resistivity and favorable slipperiness to reduce eddy-current loss and achieve high withstand voltage characteristics.

Japanese Unexamined Patent Application Publication Nos. 2009-120915, 2018-120966, 2022-169638, 2022-174132, and 10-154613 disclose a metal magnetic powder in which an insulating coating with which soft magnetic metal particles (for example, pure iron powder) are coated contains a phosphorus element.

### SUMMARY

The insulating coating with which the soft magnetic metal particles are coated disclosed in Japanese Unexamined Patent Application Publication Nos. 2009-120915, 2018-120966, 2022-169638, 2022-174132, and 10-154613 contains a phosphorus element, and phosphorus has a hygroscopic nature. Therefore, when the phosphorus element in the insulating coating absorbs moisture, the corrosion rate of the soft magnetic metal particles increases and oxidation of the soft magnetic metal particles is accelerated, and as a result, the surface roughness of the soft magnetic metal particles is likely to increase. When the soft magnetic metal particles having rough surfaces are coated with the insulating coating, the resistivity of the insulating coating decreases due to the interfacial resistance between the soft magnetic metal particle and the insulating coating. In addition, since the surface roughness of the insulating coating, with which the soft magnetic metal particles having rough surfaces are coated, also increases, a soft magnetic metal powder (a powder of soft magnetic metal particles coated with the insulating coating) has low slipperiness. This leads to a decrease in packing properties of the soft magnetic metal powder in production of powder magnetic cores, resulting in a decrease in withstand voltage characteristics.

In view of the above circumstances, the present disclosure provides a soft magnetic metal magnetic powder including soft magnetic metal particles coated with an insulating coating that has improved volume resistivity and slipperiness, an inductor, and a method of producing the soft magnetic metal magnetic powder.

A soft magnetic metal powder according to the present disclosure includes a soft magnetic metal particle; and an insulating coating with which the soft magnetic metal particle is coated. The insulating coating contains sulfur in an amount of 350 ppm or more and 1390 ppm or less (i.e., from 350 ppm to 1390 ppm) based on the total amount of the insulating coating.

An inductor according to the present disclosure includes a base body including the above-described soft magnetic metal powder; and a coil provided in the base body.

A method of producing a soft magnetic metal powder according to the present disclosure includes a step of preparing a soft magnetic metal particle; and a step of coating the soft magnetic metal particle with an insulating coating containing sulfur in an amount of 350 ppm or more and 1390 ppm or less (i.e., from 350 ppm to 1390 ppm) based on the total amount of the insulating coating by subjecting the soft magnetic metal particle to a surface treatment with an aqueous solution containing sulfur.

According to the present disclosure, a soft magnetic metal magnetic powder including soft magnetic metal particles coated with an insulating coating that has improved volume resistivity and slipperiness, an inductor, and a method of producing the soft magnetic metal magnetic powder can be provided.

### BRIEF DESCRIPTION OF THE DRAWINGS

FIG. 1 is a perspective view of an inductor of the present disclosure;

FIG. 2 is an exploded perspective view of one embodiment of the inductor of the present disclosure;

FIG. 3 is a cross-sectional view of a region defined by dashed lines in FIG. 2 as viewed in the direction of the arrows of line III-III;

FIG. 4 is a perspective view of another embodiment of the inductor of the present disclosure;

FIG. 5 is a flowchart for explaining steps of producing a soft magnetic metal powder of the present disclosure;

FIG. 6 shows STEM-EDX mapping images (a) through (e) of the soft magnetic metal powder;

FIG. 7 is a table showing results of demonstration tests; and

FIG. 8 is a table showing results of a demonstration test.

### DETAILED DESCRIPTION

A soft magnetic metal powder, an inductor, and a method of producing the soft magnetic metal powder of the present disclosure will be described below in detail. Although the description will be given with reference to the drawings as necessary, the matters shown in the drawings are merely schematically and exemplarily shown for facilitating understanding of the present disclosure, and features such as appearance and dimensional ratios may differ from those of an actual product.

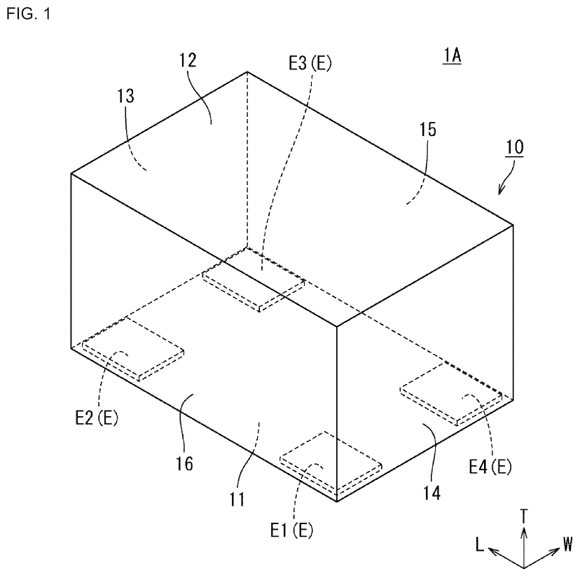

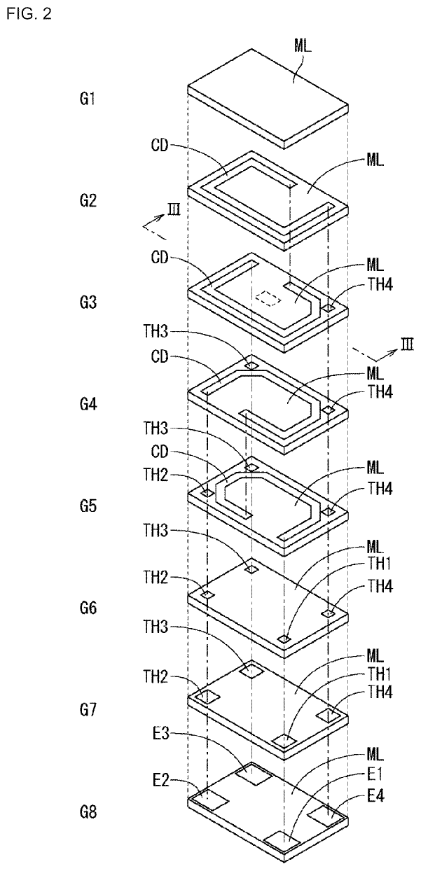

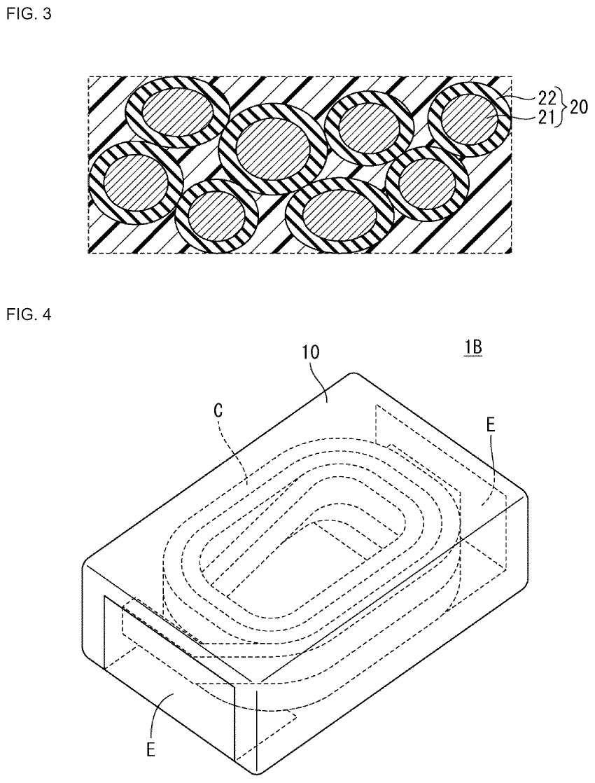

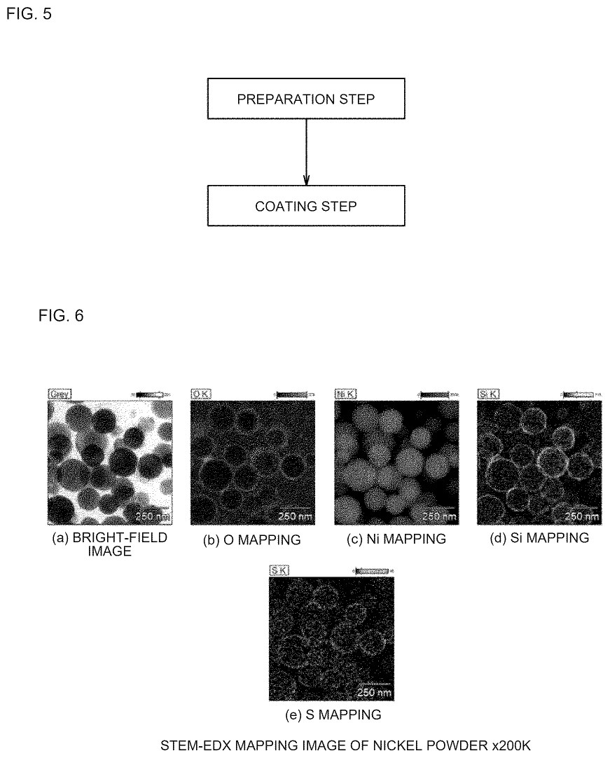

FIG. 1 is a perspective view of the inductor of the present disclosure, FIG. 2 is an exploded perspective view of one embodiment of the inductor of the present disclosure, FIG. 3 is a cross-sectional view of a region defined by dashed lines in FIG. 2 as viewed in the direction of the arrows of line III-III, FIG. 4 is a perspective view of another embodiment of the inductor of the present disclosure, and FIG. 5 is a flowchart for explaining steps of producing the soft magnetic metal powder of the present disclosure.

### Description of Soft Magnetic Metal Powder of the Present Disclosure

First, the soft magnetic metal powder of the present disclosure will be described. A soft magnetic metal powder 20 includes a soft magnetic metal particle 21 and an insulating coating 22 with which the soft magnetic metal particle 21 is coated (see FIG. 3).

For example, the soft magnetic metal particle 21 is composed of nickel. Such a soft magnetic metal material can provide suitable permeability when used for an inductor. The soft magnetic metal particle 21 may be composed of an Fe—Ni-based alloy (permalloy), an Fe—Si—Cr (chromium)-based alloy, an Fe—Si—Al (aluminum)-based alloy, an Fe—Si—B (boron)-P (phosphorus)-Cu (copper)-C (carbon)-based alloy, an Fe—Si—B—Nb (niobium)-Cu-based alloy, a Ni-containing alloy, Fe, or the like. In addition, the soft magnetic metal particle 21 which contains Fe and Si may contain impurities such as Cr, Mn (manganese), Cu, Ni (nickel), P, S (sulfur), and Co (cobalt) that are not intentionally introduced during production. The soft magnetic metal particles 21 may be contained in a magnetic paste, which will be described in detail in description of the production method. Note that a resin component contained in the magnetic paste may be either removed by heat treatment or remain.

The insulating coating 22 has insulating properties. The term “insulating properties” as used herein refers to a volume resistivity of 1 MΩcm or more. The insulating coating 22 contains sulfur in an amount of 350 ppm or more and 1390 ppm or less (i.e., from 350 ppm to 1390 ppm) based on the total amount of the insulating coating. More specifically, the insulating coating 22 contains a Si element, an O element, and a S element.

The ion content in the insulating coating 22 can be measured by an oxygen stream combustion-infrared absorption method. The “oxygen stream combustion-infrared absorption method” as used herein refers to the following method. Specifically, a sample (a soft magnetic metal powder) is combusted in an oxygen carrier together with a combustion aid in a high-frequency induction heating furnace using an analysis apparatus (HORIBA, Ltd., model: EMIA-920V2/FA). After carbon in the sample is converted to carbon dioxide (CO₂) and carbon monoxide (CO), sulfur is converted to sulfur dioxide (SO₂), and hydrogen is converted to water (H₂O), the water (H₂O) is removed with a dehydrating agent, and CO₂, CO, and SO₂ contained in the oxygen carrier are each detected with an infrared detector. Note that the ion content is not necessarily measured by the above method. For example, the insulating coating on the surface of the soft magnetic metal powder may be locally analyzed by the laser ablation ICP mass spectrometry (LA-ICP-MS). In the oxygen stream combustion-infrared absorption method, the material of the soft magnetic metal particle may have an influence; however, in the laser ablation ICP mass spectrometry (for example, an analysis method using Agilent 7500 series ICP-MS manufactured by Agilent Technologies), the elements contained in the insulating coating are measured by irradiating the insulating coating on the surface of the soft magnetic metal powder with laser light and thereby causing the insulating coating to evaporate into microparticles with the energy generated therefrom, and therefore, microsized regions and extreme surface layers can be measured by controlling the laser light.

In the soft magnetic metal powder 20 of the present disclosure, the insulating coating 22 contains sulfur in an amount of 350 ppm or more and 1390 ppm or less (i.e., from 350 ppm to 1390 ppm) based on the total amount of the insulating coating. Sulfur is poorly soluble in water and is unlikely to react with atmospheric moisture. Therefore, corrosion on the surfaces of the soft magnetic metal particles 21 due to a reaction between the soft magnetic metal powder and moisture can be reduced, and the volume resistivity of the soft magnetic metal particles and the insulating coating can be increased. In addition, the reduction in corrosion on the surfaces of the soft magnetic metal particles 21 contributes to reducing surface roughness, resulting in improved slipperiness of the soft magnetic metal powder 20.

Furthermore, as will be described in detail in the following Examples, there is an appropriate range of the sulfur content. Specifically, when the sulfur content is less than a predetermined amount, oxidation of the soft magnetic metal particles is not sufficiently inhibited due to the influence of atmospheric moisture. When the sulfur content is more than a predetermined amount, surrounding sulfur atoms form disulfide bonds, resulting in swelling due to atmospheric moisture. Therefore, the appropriate range of the sulfur content is set to 350 ppm or more and 1390 ppm or less (i.e., from 350 ppm to 1390 ppm) based on the total amount of the insulating coating. With such an appropriate range of the sulfur content, sulfur at the interface between the insulating coating 22 and the soft magnetic metal particle 21 also acts as an electron nucleophile and therefore has an electron-withdrawing property. The terminal functional group of an organosilane (silane coupling agent) is a methyl group, which has an electron-donating property. Due to a strong electrostatic interaction, the organosilane is properly adsorbed on the surfaces of the soft magnetic metal particles 21, resulting in improved slipperiness of the soft magnetic metal powder 20.

As a preferred aspect of the insulating coating 22, the phosphorus content of the insulating coating 22 is 0 ppm or more and 780 ppm or less (i.e., from 0 ppm to 780 ppm) based on the total amount of the insulating coating. A lower phosphorus content of the insulating coating 22 is preferable because it can reduce reaction with atmospheric moisture; however, since the soft magnetic metal powder 20 of the present disclosure contains sulfur, phosphorus may be contained in an amount of 0 ppm or more and 780 ppm or less (i.e., from 0 ppm to 780 ppm) based on the total amount of the insulating coating. Even with the soft magnetic metal powder 20 as described above, appropriate volume resistivity and slipperiness can be achieved, as will be described in detail in the following Examples.

A preferred average particle diameter of the soft magnetic metal powder 20 may be 1 μm or more and 30 μm or less (i.e., from 1 μm to 30 μm). The average particle diameter of the soft magnetic metal powder 20 can be measured by the following procedure. An inductor sample is cut to obtain a cross section of the sample. Specifically, the sample is cut along a line that passes through a winding axis of a coil of a base body and is orthogonal to a mounting surface and end surfaces of the base body, thereby obtaining the cross section of the sample. A plurality of regions (for example, five regions of 130 μm×100 μm each) of the resulting cross section are imaged by SEM, and the resulting SEM images are analyzed by image analysis software (for example, image analysis software “Win R00F” (provided by MITANI CORPORATION)), thereby obtaining equivalent circle diameters of the soft magnetic metal powder. An average value of the resulting equivalent circle diameters is defined as the average particle diameter of the soft magnetic metal powder. The “average particle diameter” as used herein may mean an average particle diameter D50 (a diameter equivalent to a volume-based cumulative percentage of 50%).

### Method of Producing Soft Magnetic Metal Powder of the Present Disclosure

Next, a method of producing the soft magnetic metal powder of the present disclosure will be described with reference to FIG. 5. The method of producing the soft magnetic metal powder of the present disclosure includes a step of preparing a soft magnetic metal particle and a step of coating the soft magnetic metal particle with an insulating coating containing sulfur in an amount of 350 ppm or more and 1390 ppm or less (i.e., from 350 ppm to 1390 ppm) based on the total amount of the insulating coating by subjecting the soft magnetic metal particle to a surface treatment with an aqueous solution containing sulfur. Description will be given below with reference to the production flowchart shown in FIG. 5.

### Step of Preparing Soft Magnetic Metal Particles

First, an aqueous metal salt solution containing the soft magnetic metal particles is prepared. For example, an aqueous metal salt solution containing a nickel element may be prepared. Next, a reducing agent solution that causes a reduction reaction in the aqueous metal salt solution containing the soft magnetic metal particles is prepared. Then, the aqueous metal salt solution and the reducing agent solution are mixed together, thereby causing a reduction-precipitation reaction. With this procedure, a slurry-like reaction solution containing the soft magnetic metal particles is produced.

### Coating Step

An aqueous solution containing a sulfur coating agent is added to the resulting slurry-like reaction solution containing the soft magnetic metal particles and mixed with the soft magnetic metal particles. This causes a sulfur component to adhere to the surfaces of the soft magnetic metal particles, thereby subjecting the soft magnetic metal particles to a surface treatment. Thereafter, solid-liquid separation treatment is performed, followed by drying, thereby obtaining soft magnetic metal particles with the surfaces treated with sulfur.

Next, slurry for forming the insulating coating 22 with which the soft magnetic metal particles are coated is prepared. As the slurry, a solution is prepared by dissolving a metal alkoxide containing Si (for example, tetraethyl orthosilicate) in an alcohol solution having an OH group (for example, isopropanol). Specifically, a solution containing a compound having a Si atom and a compound having an OH group is prepared. Note that a phosphate ester anionic surfactant (an aqueous solution containing phosphorus) may be added to the solution so that phosphorus is contained in an amount of 0 ppm or more and 780 ppm or less (i.e., from 0 ppm to 780 ppm) based on the total amount of the insulating coating.

The soft magnetic metal particles with the surfaces treated with sulfur are added to the slurry for forming the insulating coating 22. In the solution, a silanol group is generated through a reaction under an alkaline environment. Note that the above alcohol solution having an OH group is not limited to isopropanol, and may be, for example, ethanol. In addition, the metal alkoxide containing Si is not limited to tetraethyl orthosilicate, and may be, for example, tetramethoxysilane.

After the soft magnetic metal particles are coated with the insulating coating through the above reaction, solid-liquid separation is performed by vacuum filtration or the like, followed by drying, thereby obtaining the soft magnetic metal powder of the present disclosure. Note that the resulting product may be subjected to some treatment such as washing (for example, acetone washing) before the solid-liquid separation. In addition, the vacuum filtration may be replaced by pressure filtration such as filter press or centrifugal filtration.

As described above, according to the method of producing the soft magnetic metal powder of the present disclosure, the insulating coating can be caused to contain sulfur in an amount of 350 ppm or more and 1390 ppm or less (i.e., from 350 ppm to 1390 ppm) based on the total amount of the insulating coating. Therefore, the sulfur contained therein can reduce corrosion on the surfaces of the soft magnetic metal particles due to a reaction between the soft magnetic metal powder and moisture, and can increase the volume resistivity of the soft magnetic metal particles and the insulating coating. In addition, the reduction in corrosion on the surfaces of the soft magnetic metal particles contributes to reducing surface roughness, resulting in improved slipperiness of the soft magnetic metal powder.

### Description of Inductor of the Present Disclosure

Next, an inductor of the present disclosure will be described with reference to FIGS. 1 to 4. The inductor of the present disclosure includes a base body 10 having the above-described soft magnetic metal powder and a coil provided in the base body 10.

The inductor of the present disclosure may be an inductor illustrated in FIG. 2 (hereinafter referred to as an inductor 1A of a first embodiment) which is composed of a plurality of base body layers G1 to G8 having coil conductors CD and magnetic layers ML, or alternatively, an inductor illustrated in FIG. 4 (hereinafter referred to as an inductor 1B of a second embodiment) which is composed of a wound conductive wire. In the following description, the inductor of the first embodiment will be described first, and thereafter the inductor of the second embodiment will be described.

Description of Inductor of first Embodiment

The base body 10 has, for example, a rectangular parallelepiped shape or a substantially rectangular parallelepiped shape having six faces. The corner portions and ridge portions of the base body 10 may be rounded. The “corner portion” refers to a portion where three faces of the base body 10 converge, and the “ridge portion” refers to a portion where two faces of the base body 10 converge.

In FIG. 1, the length direction, the width direction, and the height direction of the inductor 1A and the base body 10 are shown as an L direction, a W direction, and a T direction, respectively. The length direction L, the width direction W, and the height direction T are orthogonal to each other. A mounting surface of the inductor 1A is, for example, a surface that is parallel to the length direction L and the width direction W (LW surface).

The base body 10 illustrated in FIG. 1 includes: a first principal surface 11 and a second principal surface 12 opposite to each other in the height direction T; a first end surface 13 and a second end surface 14 orthogonal to the height direction T and opposite to each other in the length direction L; and a first lateral surface 15 and a second lateral surface 16 opposite to each other in the width direction W orthogonal to the length direction L and the height direction T. In the example illustrated in FIG. 1, the first principal surface 11 of the base body 10 corresponds to the mounting surface (bottom surface) of the base body 10. Note that the second principal surface 12 may serve as the mounting surface of the base body 10.

The base body 10 has a multilayer structure including a plurality of base body layers having the magnetic layers ML and the coil conductors CD, which are laminated in the lamination direction (for example, the height direction T). In the present embodiment, the base body 10 is composed of the base body layers G1 to G8 laminated together as illustrated in FIG. 2. In addition, the coil is composed of the plurality of coil conductors CD laminated together. Since the coil is composed of the coil conductors CD laminated together, the coil can be reduced in size as compared to a coil C of the second embodiment described later. Note that interfaces between the layers of the multilayer structure of the base body 10 are eliminated. Each of the base body layers G1 to G8 may include a plurality of layers having the same pattern.

The coil composed of the plurality of coil conductors CD laminated together is provided in the base body 10. In the example illustrated in FIG. 2, two coils (a first coil and a second coil) are disposed along the lamination direction in the base body 10. More specifically, the first coil is composed of the coil conductors CD of the base body layer G4 and the base body layer G5, and the second coil is composed of the coil conductors CD of the base body layer G2 and the base body layer G3. Note that the inductor 1A of the first embodiment is not limited to this example. For example, three or more coils may be disposed along the lamination direction. Alternatively, a plurality of coils may be disposed side by side along a direction intersecting with the lamination direction (along the L direction in FIG. 1) in the inside of the base body 10 to form a coil array.

The mounting surface (the first principal surface 11) of the base body 10 is provided with outer electrodes E. In the example illustrated in FIG. 2, the outer electrodes E have a first outer electrode E1 and a second outer electrode E2 each connected to a corresponding one of the end portions of the first coil, and a third outer electrode E3 and a fourth outer electrode E4 each connected to a corresponding one of the end portions of the second coil. The number of outer electrodes is set to two for each coil. Therefore, when the number of coils is set to three, the number of outer electrodes may be set to six.

The coil and the outer electrodes E may be connected via through-hole conductors TH. Specifically, a first through-hole conductor TH1 to a fourth through-hole conductor TH4 may be provided in correspondence with the first outer electrode E1 to the fourth outer electrode E4. The first through-hole conductor TH1 to the fourth through-hole conductor TH4 may extend along the lamination direction.

The above-described soft magnetic metal powder 20 is used to produce the base body 10 of the inductor of the present disclosure. Therefore, according to the inductor of the present disclosure, the insulating coating 22 can be caused to contain sulfur in an amount of 350 ppm or more and 1390 ppm or less (i.e., from 350 ppm to 1390 ppm) based on the total amount of the insulating coating. Therefore, the sulfur contained therein can reduce corrosion on the surfaces of the soft magnetic metal particles 21 due to a reaction between the soft magnetic metal powder 20 and moisture, and can increase the volume resistivity of the soft magnetic metal particles 21 and the insulating coating 22. In addition, the reduction in corrosion on the surfaces of the soft magnetic metal particles 21 contributes to reducing surface roughness, resulting in improved slipperiness of the soft magnetic metal powder 20.

One example of a method of identifying the insulating coating 22 of the soft magnetic metal particles 21 from the inductor of the present disclosure is as described below.
(1) The base body 10 is cut in the height direction of the base body 10 from the mounting surface side of the base body 10 at a position passing through the winding axis of a coil C along the length direction of the base body 10, thereby preparing a cut surface.
(2) On the cut surface, a portion corresponding to the winding axis of the coil C is imaged by SEM and/or EDX at a magnification of 1000 times such that the soft magnetic metal powder 20 is within the imaging field, thereby identifying materials of the soft magnetic metal particles 21 and the insulating coating 22.

In addition, the inductor 1A of the first embodiment has portions where the insulating coatings 22 of the soft magnetic metal powder 20 are bonded in the base body 10 (see FIG. 3), since the base body 10 is formed by laminating the magnetic layers ML and the coil conductors CD, followed by firing. Furthermore, after the magnetic layers ML and the coil conductors CD are laminated and fired, gaps of the soft magnetic metal powder 20 are impregnated with a resin. Therefore, the base body 10 has an increased rigidity due to the bonding between the insulating coatings 22 of the soft magnetic metal powder 20 as compared to those having soft magnetic metal powder particles merely in contact with each other.

### Description of Inductor of Second Embodiment

Next, the inductor 1B of the second embodiment will be described with reference to FIG. 4. Components common to the inductor 1A of the first embodiment will be omitted from the description as appropriate.

According to the inductor 1B of the second embodiment, a conductive wire is wound to form the coil C, and the coil C is embedded in the inside of the base body 10.

The conductive wire is preferably a rectangular wire, which provides effects of enabling high-density winding without gaps between adjacent portions of the wire and reducing DC resistance. Note that the conductive wire is not limited to this example, and may be, for example, a round wire.

The conductive wire is preferably a metal wire (for example, copper wire) coated with an insulating material such as a resin. In this case, in combination with a resin (for example, epoxy resin) contained in the base body 10, which will be described later, the coil C can be firmly molded in the base body 10.

The base body 10 further contains a resin, in addition to the above-described soft magnetic metal powder 20. By incorporating the resin into the base body 10 and curing the resin, particles of the soft magnetic metal powder 20 are brought into contact with each other. The resin may be, for example, an epoxy resin and/or a phenoxy resin having thermosetting properties. The amount of the resin may be 2 wt % or more and 3.5 wt % or less (i.e., from 2 wt % to 3.5 wt %), more preferably 2.7 wt % or more and 3.0 wt % or less (i.e., from 2.7 wt % to 3.0 wt %) based on the total weight of the soft magnetic metal powder 20 and the resin.

In the base body 10 of the inductor 1B of the second embodiment, the soft magnetic metal powder 20 may be composed of first magnetic powder and second magnetic powder smaller in average particle diameter than the first magnetic powder. With this configuration, the second magnetic powder smaller in average particle diameter than the first magnetic powder enters gaps between particles of the first magnetic powder, resulting in an improved packing fraction of the soft magnetic metal powder in the base body 10.

The soft magnetic metal powder 20 which corresponds to the first magnetic powder may have an average particle diameter of 20 μm or more and 30 μm or less (i.e., from 20 μm to 30 μm), more preferably 21.4 μm or more and 27.4 μm or less (i.e., from 21.4 μm to 27.4 μm). On the other hand, the second magnetic powder may have an average particle diameter of 1 μm or more and 10 μm or less (i.e., from 1 μm to 10 μm), more preferably 1.5 μm or more and 1.8 μm or less (i.e., from 1.5 μm to 1.8 μm).

The first magnetic powder is composed of an alloy containing a nickel element. The first magnetic powder may have an oxide film.

The second magnetic powder is carbonyl iron powder. The second magnetic powder may have an oxide film. The material of the second magnetic powder may be the same as or different from that of the first magnetic powder. Either one of the first magnetic powder and the second magnetic powder may be coated with the insulating coating 22 to be formed into the soft magnetic metal powder, or both of the first magnetic powder and the second magnetic powder may be coated with the insulating coating 22 to be formed into the soft magnetic metal powder. By coating at least one of the first magnetic powder and the second magnetic powder, which differ from each other in average particle diameter, with the insulating coating 22 to be formed into the soft magnetic metal powder, slipperiness between the first magnetic powder and the second magnetic powder can be improved, resulting in an improved packing fraction of the soft magnetic metal powder in the base body 10.

The amount of the first magnetic powder may be 70 wt % or more and 85 wt % or less (i.e., from 70 wt % to 85 wt %), preferably 70 wt % or more and 80 wt % or less (i.e., from 70 wt % to 80 wt %) based on the total weight of the first magnetic powder and the second magnetic powder. The amount of the second magnetic powder may be 15 wt % or more and 30 wt % or less (i.e., from 15 wt % to 30 wt %), preferably 20 wt % or more and 30 wt % or less (i.e., from 20 wt % to 30 wt %).

### EXAMPLES

Demonstration tests regarding the soft magnetic metal powder of the present disclosure will be described in detail. Specifically, soft magnetic metal powders of the following Examples 1 to 8 and Comparative Examples 1 to 3 were produced.

### Example 1

(Step 1) Weighed were 20 g of nickel sulfate hexahydrate (FUJIFILM Wako Pure Chemical Corporation) as a metal salt, 1.52 mg of copper sulfate pentahydrate (FUJIFILM Wako Pure Chemical Corporation) as a noble metal catalyst, 7 g of L-arginine (Tokyo Chemical Industry Co., Ltd.) as a basic amino acid, and 24 g of trisodium citrate dihydrate. The weighed materials were dissolved in pure water, thereby preparing an aqueous metal salt solution.
(Step 2) Weighed were 65 g of 60% hydrazine hydrate (Otsuka Chemical Co., Ltd.) and 57 g of sodium hydroxide (Tosoh Corporation) as a pH adjuster. The weighed materials were dissolved in 280 mL of pure water, thereby preparing a reducing agent solution.
(Step 3) Each of the aqueous metal salt solution and the reducing agent solution was heated to a liquid temperature of 60 °C. Then, the two solutions were stirred and mixed to prepare a mixed solution, thereby initiating a reduction-precipitation reaction. The mixed solution had a pH of 13 at the start of the precipitation reaction. The reaction solution underwent a change due to nucleation caused by the action of the noble metal catalyst after 2 to 3 minutes from the start of the reaction, and the reduction reaction was further continued for 2 hours while stirring, thereby obtaining nickel precipitated powder.
(Step 4) The resulting reaction solution containing the nickel precipitated powder was in the form of slurry. An aqueous solution prepared by dissolving 14 mg of thiomalic acid (Tokyo Chemical Industry Co., Ltd.) as a sulfur coating agent was added to the nickel precipitated powder slurry, thereby subjecting the nickel precipitated powder to a surface treatment. After the surface treatment, solid-liquid separation was performed using pure water, followed by drying in a vacuum dryer set to a temperature of 150 °C, thereby obtaining nickel powder having a surface treated with sulfur.
(Step 5) The nickel powder having a surface treated with sulfur in an amount of 50 g was added to a mixed solution of 20.5 g of isopropanol (Kanto Chemical Co., Inc.) and 20.5 g of 9% ammonia water (Taisei Kakou Corporation). Thereafter, 0.58 g of PLYSURF AL (DKS Co. Ltd.) and 5.98 mL of tetraethyl orthosilicate (hereinafter may be referred to as TEOS) (Kanto Chemical Co., Inc.) were added thereto, followed by stirring for 30 minutes.
(Step 6) After the stirring in Step 5, 660 μL of TEOS and 680 μL of organosilane (Shin-Etsu Chemical Co., Ltd.) were added thereto, followed by stirring for 1 hour.
(Step 7) After the stirring in Step 6, the nickel powder slurry was subjected to solid-liquid separation by vacuum filtration, and surfaces of the powder were washed with acetone (Nacalai Tesque, Inc.). The resulting material was dried for a whole day, thereby obtaining a soft magnetic metal powder having an insulating coating, which is a silica coating containing sulfur.

### Example 2

In (Step 4) of Example 1, the amount of thiomalic acid was set to 7 mg. In other respects, a soft magnetic metal powder was produced through the same steps as in Example 1.

### Example 3

In (Step 4) of Example 1, the amount of thiomalic acid was set to 6 mg. In other respects, a soft magnetic metal powder was produced through the same steps as in Example 1.

### Example 4

In (Step 4) of Example 1, the amount of thiomalic acid was set to 7 mg. In addition, in (Step 5) of Example 1, the amount of PLYSURF AL was set to 0.60 g. In other respects, a soft magnetic metal powder was produced through the same steps as in Example 1.

### Example 5

In (Step 4) of Example 1, the amount of thiomalic acid was set to 28 mg. In other respects, a soft magnetic metal powder was produced through the same steps as in Example 1.

### Example 6

In (Step 4) of Example 1, the amount of thiomalic acid was set to 29 mg. In other respects, a soft magnetic metal powder was produced through the same steps as in Example 1.

### Example 7

In (Step 5) of Example 1, the amount of PLYSURF AL was set to 0.29 g. In other respects, a soft magnetic metal powder was produced through the same steps as in Example 1.

### Example 8

In (Step 5) of Example 1, PLYSURF AL was not added, and instead 0.29 g of polyvinylpyrrolidone (Pitscol K-30, DKS Co. Ltd.) was added. In other respects, a soft magnetic metal powder was produced through the same steps as in Example 1.

### Comparative Example 1

(Step 1) to (Step 4) of Example 1 were performed, but (Step 5) and (Step 6) were not performed. Specifically, metal magnetic particles without the insulating coating were produced.

### Comparative Example 2

In (Step 4) of Example 1, the amount of thiomalic acid was set to 56 mg. In other respects, a soft magnetic metal powder was produced through the same steps as in Example 1.

### Comparative Example 3

In (Step 4) of Example 1, the amount of thiomalic acid was set to 30 mg, and in (Step 5) of Example 1, the amount of PLYSURF AL was set to 1.16 g. In other respects, a soft magnetic metal powder was produced through the same steps as in Example 1.

The soft magnetic metal powders of Examples 1 to 8 and Comparative Examples 1 to 3 described above were subjected to the following demonstration tests.

### (Demonstration Test 1: STEM-EDX Measurement)

The soft magnetic metal powder of Example 1 was subjected to STEM-EDX measurement. STEM images (a) through (e) are shown in FIG. 6. It can be understood from FIG. 6 that nickel is present in the regions corresponding to the soft magnetic metal particles, and an oxygen element, a silicon element, and a sulfur element are present on the outer surfaces of the soft magnetic metal particles. Although an oxygen element, a silicon element, and a sulfur element also appear to be present in the regions corresponding to the soft magnetic metal particles in the oxygen element mapping, the silicon element mapping, and the sulfur element mapping shown in FIG. 6, this is because deposits adhering to the cross sections of the nickel components appear as noise, resulting from trimming performed to form the cross sections of the nickel components. Therefore, an oxygen element, a silicon element, and a sulfur element are substantially absent from the regions corresponding to the soft magnetic metal particles.

### (Demonstration Test 2: Measurement of Sulfur Element Content)

The soft magnetic metal powders of Examples 1 to 8 and Comparative Examples 1 to 3 were measured to determine the sulfur element content. The sulfur element content was measured by the above-described “oxygen stream combustion-infrared absorption method” using an analysis apparatus (HORIBA, Ltd., model: EMIA-920V2/FA). In the present disclosure, the “oxygen stream combustion-infrared absorption method” was employed to measure the sulfur element content; however, in the case where the analysis is performed by LA-ICP-MS (laser ablation ICP mass spectrometry), Agilent 7500 manufactured by Agilent Technologies may be used to measure the sulfur content of the insulating coating by irradiating the insulating coating present on the surface of the soft magnetic metal powder with laser beams to evaporate and atomize the insulating coating with the energy thereof.

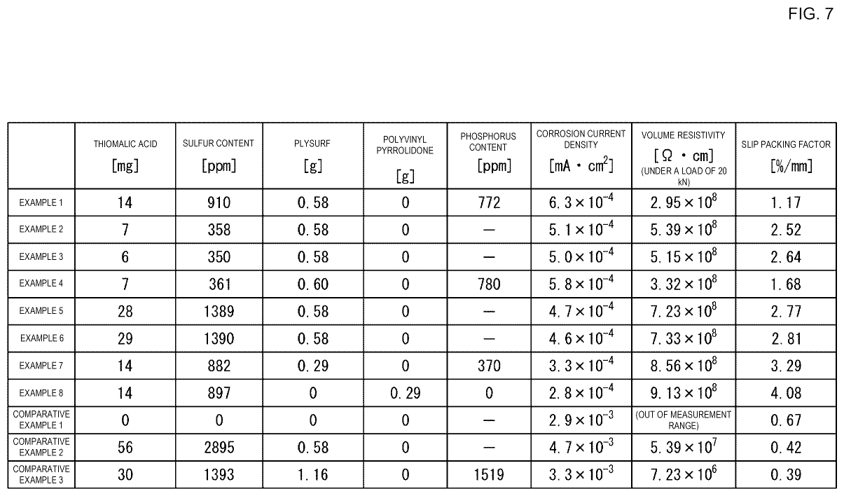

As a result of the above measurement, the soft magnetic metal powders of Examples 1 to 8 had a sulfur element in an amount of 350 ppm or more and 1390 ppm or less (i.e., from 350 ppm to 1390 ppm) in the insulating coating as shown in FIG. 7. On the other hand, the sulfur element content of each of Comparative Examples 1 to 3 was out of the range defined by the above-described numerical values.

### (Demonstration Test 3: Measurement of Phosphorus Element Content)

The soft magnetic metal powders of Examples 1 to 8 and Comparative Examples 1 to 3 were measured to determine the phosphorus element content. The phosphorus element content was measured using ICP-AES analysis apparatuses: an ICP optical emission spectrometer (iCAP6300 radial, Thermo Fisher Scientific K.K.) and an atomic absorption spectrometer (iCE3300, Thermo Fisher Scientific K.K.). In the present disclosure, the ICP-AES analysis was employed to measure the phosphorus element content; however, in the case where the analysis is performed by LA-ICP-MS (laser ablation ICP mass spectrometry), Agilent 7500 manufactured by Agilent Technologies may be used to measure the phosphorus content of the insulating coating by irradiating the insulating coating present on the surface of the soft magnetic metal powder with laser beams to evaporate and atomize the insulating coating with the energy thereof.

As a result of the above measurement, the soft magnetic metal powders of Examples 1 to 8 had a phosphorus element in an amount of 0 ppm or more and 780 ppm or less (i.e., from 0 ppm to 780 ppm) in the insulating coating as shown in FIG. 7. On the other hand, the phosphorus element content of Comparative Example 3 was out of the range defined by the above-described numerical values.

### (Demonstration Test 4: Measurement of Corrosion Current Density)

The corrosion current density at room temperature was measured using an electrochemical system (manufactured by Hokuto Denko Corporation, model: HZ-5000). As a sample to measure the corrosion current density, a carbon paste working electrode was prepared by mixing, with a spatula, each of the soft magnetic metal powders of Examples 1 to 8 and Comparative Examples 1 to 3 with a carbon paste at a mass ratio of 2:1. In addition, 3 mass % of an aqueous NaCl solution was added to a glass cell, and the above-described carbon paste working electrode, a Ag/AgCl electrode, and a Pt counter electrode were inserted therein, thereby preparing a three-electrode cell. Then, the corrosion current density was determined by the Tafel extrapolation method.

The results of the measurement of the corrosion current density are shown in FIG. 7. In the results shown in FIG. 7, a smaller numerical value of “corrosion current density” indicates greater inhibition of the surface corrosion. The soft magnetic metal powders of Examples 1 to 8 had smaller corrosion current densities than the soft magnetic metal powders of Comparative Examples 1 to 3. Accordingly, the results showed that the corrosion on the surface was properly inhibited in the cases of the soft magnetic metal powders of Examples 1 to 8.

### (Demonstration Test 5: Measurement of Volume Resistivity)

The volume resistivity of the soft magnetic metal powder was measured using a powder resistivity meter (manufactured by Mitsubishi Chemical Analytech Co., Ltd., model: Hiresta-UX MCP-HT800). For the measurement, the soft magnetic metal powder was placed in a dedicated jig, and the volume resistivity was measured at loads of 4 kN to 20 kN by varying the pressure condition in 4 kN increments. The measurement results shown in FIG. 7 correspond to the data obtained at a load of 20 kN.

The results of the measurement of the volume resistivity are shown in FIG. 7. In the results shown in FIG. 7, a greater numerical value of “volume resistivity” indicates higher insulating properties due to the insulating coating. The soft magnetic metal powders of Examples 1 to 8 had greater volume resistivities than the soft magnetic metal powders of Comparative Examples 1 to 3. Accordingly, the results showed that the soft magnetic metal powders of Examples 1 to 8 had higher insulating properties than the soft magnetic metal powders of Comparative Examples 1 to 3.

### (Demonstration Test 6: Slip Packing Factor)

The slipperiness of the nickel powder was evaluated using a powder layer shear force measuring apparatus (NS-S500, Nano Seeds Corporation). The measurement conditions were set such that the indentation load was 150 N, the powder dish had a diameter of 15 mm, and the dish had a gap of 0.2 mm.

The results of the measurement of the slip packing factor are shown in FIG. 7. In the results shown in FIG. 7, a greater numerical value of “slip packing factor” indicates greater slipperiness. The soft magnetic metal powders of Examples 1 to 8 had greater slip packing factors than the soft magnetic metal powders of Comparative Examples 1 to 3.

Next, a demonstration test regarding the inductor including the soft magnetic metal powder of the present disclosure will be described in detail. Specifically, powder magnetic cores according to Examples 9 to 16 and Comparative Example 4 described below used for an inductor were produced.

### Example 9

(Step 1) The soft magnetic metal powder described in Example 1 was mixed with a mixed solution containing an epoxy resin (thermosetting resin), an imide resin (curing agent), and acetone, and acetone was vaporized, thereby obtaining granules. Note that the total mass of the epoxy resin and the imide resin was set to 3 mass % relative to the mass of the powder.
(Step 2) The granules were subjected to sizing using a stainless steel sieve. The stainless steel sieve had a mesh opening of 180 μm. The granules were subjected to molding using a mold having a toroidal shape, thereby obtaining a molded article. The mold had an inner diameter of 6.5 mm, and an outer diameter of 11 mm. The molding pressure was set to 3.0 t/cm². The molded article was heated at 180 °C for 1 hour to cure the epoxy resin, thereby obtaining a powder magnetic core having a toroidal shape.

### Example 10

A powder magnetic core was produced through the same steps as in Example 9, except that the soft magnetic metal powder described in Example 2 was used in (Step 1) of Example 9.

### Example 11

A powder magnetic core was produced through the same steps as in Example 9, except that the soft magnetic metal powder described in Example 3 was used in (Step 1) of Example 9.

### Example 12

A powder magnetic core was produced through the same steps as in Example 9, except that the soft magnetic metal powder described in Example 4 was used in (Step 1) of Example 9.

### Example 13

A powder magnetic core was produced through the same steps as in Example 9, except that the soft magnetic metal powder described in Example 5 was used in (Step 1) of Example 9.

### Example 14

A powder magnetic core was produced through the same steps as in Example 9, except that the soft magnetic metal powder described in Example 6 was used in (Step 1) of Example 9.

### Example 15

A powder magnetic core was produced through the same steps as in Example 9, except that the soft magnetic metal powder described in Example 7 was used in (Step 1) of Example 9.

### Example 16

A powder magnetic core was produced through the same steps as in Example 9, except that the soft magnetic metal powder described in Example 8 was used in (Step 1) of Example 9.

### Comparative Example 4

A powder magnetic core was produced through the same steps as in Example 9, except that the soft magnetic metal powder described in Comparative Example 1 was used in (Step 1) of Example 9.

### (Demonstration Test 7: Measurement of Withstand Voltage)

A voltage was applied to the powder magnetic core using a digital ultra-high resistance/micro-current meter (model: R8340A, manufacturer: ADC Corporation). While the voltage was continuously increased, a current in the powder magnetic core was continuously measured. The withstand voltage of the powder magnetic core was defined as the voltage at which a current in the powder magnetic core reached 1 mA.

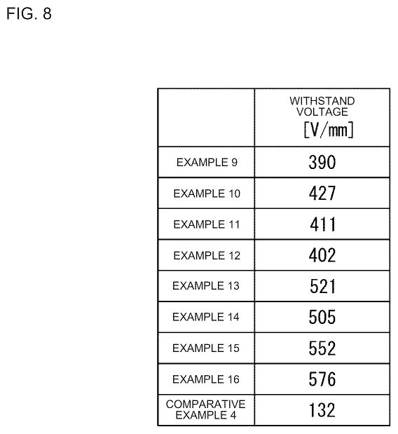

The results of the measurement of the withstand voltage are shown in FIG. 8. In the results shown in FIG. 8, a greater numerical value of “withstand voltage” indicates resistance to higher voltages. The soft magnetic metal powders of Examples 1 to 8 were greater in withstand voltage than the soft magnetic metal powders of Comparative Examples 1 to 3. Accordingly, the results showed that the powder magnetic cores of Examples 9 to 16 had greater withstand voltage characteristics than the powder magnetic core of Comparative Example 4.

Note that the embodiments disclosed herein are illustrative in all respects and should not be construed as limiting. Accordingly, the technical scope of the present disclosure is not to be interpreted solely on the basis of the above-described embodiments, but is to be defined on the basis of the claims. The technical scope of the present disclosure also encompasses all modifications within the meaning and scope equivalent to the claims.

Aspects of the soft magnetic metal powder, the inductor, and the method of producing the soft magnetic metal powder according to the present disclosure are as described below.
<1> A soft magnetic metal powder including: a soft magnetic metal particle; and an insulating coating with which the soft magnetic metal particle is coated. The insulating coating contains sulfur in an amount of 350 ppm or more and 1390 ppm or less (i.e., from 350 ppm to 1390 ppm) based on a total amount of the insulating coating.
<2> The soft magnetic metal powder according to <1>, wherein the insulating coating contains phosphorus in an amount of 0 ppm or more and 780 ppm or less (i.e., from 0 ppm to 780 ppm) based on the total amount of the insulating coating.
<3> The soft magnetic metal powder according to <1> or <2>, wherein the soft magnetic metal particle is composed of nickel or an alloy containing a nickel element.
<4> An inductor including a base body including the soft magnetic metal powder according to any one of <1> to <3>; and a coil provided in the base body.
<5> The inductor according to <4>, wherein the coil is composed of a plurality of conductor layers laminated together.
<6> The inductor according to <4>, wherein the coil is composed of a conductive wire that is wound.
<7> The inductor according to any one of <4> to <6>, wherein the base body includes a first magnetic particle and a second magnetic particle smaller in average particle diameter than the first magnetic particle, and at least one of the first magnetic particle and the second magnetic particle comprises the soft magnetic metal particle.
<8> A method of producing a soft magnetic metal powder, the method including a coating step including a soft magnetic metal particle surface treatment process and a coating process, the soft magnetic metal particle surface treatment process including causing a sulfur component to adhere to a surface of a soft magnetic metal particle by adding an aqueous solution containing sulfur to the soft magnetic metal particle and mixing the soft magnetic metal particle with the aqueous solution, followed by drying, the coating process including coating the soft magnetic metal particle with an insulating coating by mixing the soft magnetic metal particle with an insulating coating material solution, followed by drying, wherein a soft magnetic metal powder in which the insulating coating formed on the surface of the soft magnetic metal particle contains sulfur in an amount of 350 ppm or more and 1390 ppm or less (i.e., from 350 ppm to 1390 ppm) based on a total amount of the insulating coating is obtained.
<9> The method of producing a soft magnetic metal powder according to <8>, wherein the coating step further includes incorporating phosphorus into the insulating coating by adding an aqueous solution containing phosphorus, and a soft magnetic metal powder in which the insulating coating formed on the surface of the soft magnetic metal particle contains phosphorus in an amount of 0 ppm or more and 780 ppm or less (i.e., from 0 ppm to 780 ppm) based on the total amount of the insulating coating is obtained.
<10> The method of producing a soft magnetic metal powder according to <8> or <9>, wherein the soft magnetic metal particle contains a nickel element.

The soft magnetic metal powder, the inductor, and the method of producing the soft magnetic metal powder according to the present disclosure are suitably employed as an electronic component in which the insulating coating with which the soft magnetic metal particles are coated has improved volume resistivity and slipperiness.

What is claimed is:

1. A soft magnetic metal powder comprising:
a soft magnetic metal particle; and
an insulating coating with which the soft magnetic metal particle is coated, wherein the insulating coating includes sulfur in an amount of from 350 ppm to 1390 ppm based on a total amount of the insulating coating.

2. The soft magnetic metal powder according to claim 1, wherein
the insulating coating includes phosphorus in an amount of from 0 ppm to 780 ppm based on the total amount of the insulating coating.

3. The soft magnetic metal powder according to claim 1, wherein
the soft magnetic metal particle includes nickel or an alloy including a nickel element.

4. An inductor comprising:
a base body including the soft magnetic metal powder according to claim 1; and
a coil in the base body.

5. The inductor according to claim 4, wherein
the coil includes a plurality of conductor layers laminated together.

6. The inductor according to claim 4, wherein
the coil includes a conductive wire that is wound.

7. The inductor according to claim 4, wherein
the base body includes a first magnetic particle and a second magnetic particle smaller in average particle diameter than the first magnetic particle, and
at least one of the first magnetic particle and the second magnetic particle comprises the soft magnetic metal particle.

8. The soft magnetic metal powder according to claim 2, wherein
the soft magnetic metal particle includes nickel or an alloy including a nickel element.

9. An inductor comprising:
a base body including the soft magnetic metal powder according to claim 2; and
a coil in the base body.

10. An inductor comprising:
a base body including the soft magnetic metal powder according to claim 3; and
a coil in the base body.

11. An inductor comprising:
a base body including the soft magnetic metal powder according to claim 8; and
a coil in the base body.

12. The inductor according to claim 9, wherein
the coil includes a plurality of conductor layers laminated together.

13. The inductor according to claim 10, wherein
the coil includes a plurality of conductor layers laminated together.

14. The inductor according to claim 9, wherein
the coil includes a conductive wire that is wound.

15. The inductor according to claim 5, wherein
the base body includes a first magnetic particle and a second magnetic particle smaller in average particle diameter than the first magnetic particle, and
at least one of the first magnetic particle and the second magnetic particle comprises the soft magnetic metal particle.

16. The inductor according to claim 6, wherein
the base body includes a first magnetic particle and a second magnetic particle smaller in average particle diameter than the first magnetic particle, and
at least one of the first magnetic particle and the second magnetic particle comprises the soft magnetic metal particle.

17. A method of producing a soft magnetic metal powder, the method comprising:
performing coating including a soft magnetic metal particle surface treatment process and a coating process, the soft magnetic metal particle surface treatment process including causing a sulfur component to adhere to a surface of a soft magnetic metal particle by adding an aqueous solution including sulfur to the soft magnetic metal particle and mixing the soft magnetic metal particle with the aqueous solution, followed by drying, the coating process including coating the soft magnetic metal particle with an insulating coating by mixing the soft magnetic metal particle with an insulating coating material solution, followed by drying, to produce
a soft magnetic metal powder in which the insulating coating formed on the surface of the soft magnetic metal particle includes sulfur in an amount of from 350 ppm to 1390 ppm based on a total amount of the insulating coating.

18. The method of producing a soft magnetic metal powder according to claim 17, wherein
the performing coating further includes incorporating phosphorus into the insulating coating by adding an aqueous solution including phosphorus to the insulating coating material solution, to produce
the soft magnetic metal powder in which the insulating coating formed on the surface of the soft magnetic metal particle includes phosphorus in an amount of from 0 ppm to 780 ppm based on the total amount of the insulating coating.

19. The method of producing a soft magnetic metal powder according to claim 17, wherein
the soft magnetic metal particle is includes nickel or an alloy including a nickel element.

20. The method of producing a soft magnetic metal powder according to claim 18, wherein
the soft magnetic metal particle is includes nickel or an alloy including a nickel element.
